(19) United States
(12) Patent Application Publication
(10) Pub. No.: US 2006/0008724 A1
(43) Pub. Date: Jan. 12, 2006

(54) Developing agent and image forming apparatus

(75) Inventor: Hiroshi Kawaguchi, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/883,825

(22) Filed: Jul. 6, 2004

(51) Int. Cl. G03G 9/08

(52) U.S. Cl. 430/108.7; 399/359; 430/108.6; 430/108.1

(57) ABSTRACT

Disclosed is a developing agent for use in an image forming apparatus which includes a toner recycle mechanism. A particulate low-resistance component and silica particles are added to the surfaces of toner particles of the developing agent. The addition amount of low-resistance component with respect to the toner particles is 0.2 to 1.0 wt %. The weight ratio of the low-resistance component in recycled toner to the low-resistance component in developed toner is 1.0 to 1.2. The low-resistance component residual ratio of unused toner after passage through an air classification apparatus is 0.95 to 1.0.

### BACKGROUND OF THE INVENTION

The present invention relates to a developing agent for use in image formation performed by, e.g., an electrostatic recording apparatus or electro-photographic apparatus.

When a particulate low-resistance component such as titanium oxide adheres to the surfaces of toner particles, it is possible to improve the flowability of the toner, suppress excess rise of charging at, e.g., a low temperature and low humidity, and decrease the difference between a charge amount at a high temperature and high humidity and a charge amount at a low temperature and low humidity. However, when this toner having the low-resistance component adhered is used to create friction with carrier which is mixed together with the toner, the particulate low-resistance component is separated from the toner surface. In a developing step, this separated low-resistance component floating in a developing agent is developed together with the toner on a photoreceptor. However, the low-resistance component hardly transfers onto a transfer medium in a transfer step, and remains on the surface of the photoreceptor after this transfer step. In a copying machine having a recycle system, the separated low-resistance component highly likely mixes in recycled toner together with the toner remaining on the photoreceptor surface after the transfer step. This makes the concentration of the low-resistance component in the recycled toner higher than that in unused toner. If this recycled toner is supplied to a developing device together with unused toner, charging characteristics become worse than those obtained by unused toner. This causes fogging or toner scattering. Also, this tendency increases with the life. Furthermore, this problem readily arises especially when toner having heat characteristics by which the toner can fix at low temperatures is used, since inferior charging occurs by carrier filming.

### BRIEF SUMMARY OF THE INVENTION

It is an object of the present invention to provide a developing agent which, even when used in an image forming apparatus having a recycle system, has stable charging characteristics throughout its life, and can form good images without causing any fogging or toner scattering.

A developing agent of the present invention is a developing agent for use in an image forming apparatus which comprises a toner recycle mechanism for collecting and reusing toner remaining on an image carrier after transfer, and applies to development a toner mixture obtained by mixing recycled toner in unused toner, containing

toner having toner particles containing a coloring agent and binder resin, and a particulate low-resistance component and silica particles added to surfaces of the toner particles,

wherein an addition amount of low-resistance component with respect to the toner particles is 0.2 to 1.0 wt %, a weight ratio of the low-resistance component in the recycled toner to the low-resistance component in toner developed on the image carrier before transfer is 1.0 to 1.2, and a low-resistance component residual ratio of the unused toner after passage through an air classification apparatus is 0.95 to 1.0.

Also, an image forming apparatus of the present invention is an image forming apparatus comprising

an image carrier,

a developing device which opposes the image carrier, contains a developing agent having toner particles containing a coloring agent and binder resin, and a particulate low-resistance component and silica particles added to surfaces of the toner particles, and forms a toner image by developing an electrostatic latent image formed on the image carrier in accordance with image information,

a toner replenishing mechanism which supplies unused toner to the developing device,

a transfer device which transfer the toner image onto a transfer medium,

a cleaning mechanism which removes toner remaining on the image carrier after transfer, and

a toner recycle mechanism which collects the removed toner, and supplies the collected toner as recycled toner to the developing device,

wherein an addition amount of low-resistance component with respect to the toner particles is 0.2 to 1.0 wt %, a weight ratio of the low-resistance component in the recycled toner to the low-resistance component in toner developed on the image carrier before transfer is 1.0 to 1.2, and a low-resistance component residual ratio of the unused toner after passage through an air classification apparatus is 0.95 to 1.0.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention and, together with the general description given above and the detailed description of the preferred embodiments given below, serve to explain the principles of the invention.

FIG. 1 is graph showing the relationship between the rotational speed of a Henschel mixer and the adhesion strength of a low-resistance component;

FIG. 2 is graph showing the relationship between the set temperature of the Henschel mixer and the adhesion strength of the low-resistance component;

FIG. 3 is graph showing the relationship between the agitation time of the Henschel mixer and the adhesion strength of the low-resistance component;

FIG. 4 is graph showing the adhesion strength of the low-resistance component when the rotational speed, set temperature, and agitation time of the Henschel mixer were changed;

FIG. 5 is a graph showing the adhesion strength when surface treatments were performed;

FIG. 6 schematically shows the internal arrangement of an example of an image forming apparatus to which a developing agent of the present invention is applicable; and

FIG. 7 shows a toner collecting mechanism used in the image forming apparatus shown in FIG. 6.

### DETAILED DESCRIPTION OF THE INVENTION

A developing agent of the present invention is used in an image forming apparatus comprising a toner recycle mechanism for collecting and reusing toner remaining on an image carrier after transfer. In this image forming apparatus, a toner mixture obtained by mixing the collected recycled toner in unused toner is applied to development.

The developing agent of the present invention contains toner having toner particles containing a coloring agent and binder resin, and a particulate low-resistance component and silica particles added to the surfaces of the toner particles.

The addition amount of low-resistance component with respect to the toner particles is 0.2 to 1.0 wt %. The ratio of the low-resistance component in the recycled toner to the low-resistance component in toner developed on the image carrier before transfer is 1.0 to 1.2. The low-resistance component residual ratio of the unused toner after passage through an air classification apparatus is 0.95 to 1.0.

Also, an image forming apparatus of the present invention is an apparatus using the developing agent described above, and comprising

an image carrier,

a developing device which opposes the image carrier, contains a developing agent having toner particles containing a coloring agent and binder resin, and a particulate low-resistance component and silica particles added to surfaces of the toner particles, and forms a toner image by developing an electrostatic latent image formed on the image carrier in accordance with image information,

a toner replenishing mechanism which supplies unused toner to the developing device,

a transfer device which transfer the toner image onto a transfer medium,

a cleaning mechanism which removes toner remaining on the image carrier after transfer, and

a toner recycle mechanism which collects the removed toner, and supplies the collected toner as recycled toner to the developing device.

In the present invention, the amount of low-resistance component with respect to the toner particles is limited, the amount of low-resistance component which separates from the toner surface is adjusted, and the amount of low-resistance component in developed toner on the image carrier is controlled. Therefore, it is possible to improve the charging characteristics of the toner, decrease the difference between a charge amount in a low-temperature, low-humidity environment and a charge amount in a high-temperature, high-humidity environment, and stably maintain the charging characteristics throughout the life. As a consequence, good images can be formed by preventing fogging, toner scattering, and the like.

The particulate low-resistance component is a particle having a resistance of 500 Ωcm or less, and a primary particle diameter of 100 μm or less, and preferably, 0.01 to 1 μm.

As this low-resistance component, titanium oxide can be preferably used.

The amount of low-resistance component which separates from the toner surface is preferably as small as possible. This amount is reduced by increasing the adhesion strength of the low-resistance component with respect to the toner particles. In the present invention, to increase this adhesion strength, the ratio of the low-resistance component in the recycled toner to the low-resistance component in the toner developed on the image carrier before transfer is limited to a predetermined range, and the low-resistance component residual ratio in unused toner after passage through an air classification apparatus is limited to a predetermined range. When both the values are 1, no separation of the low-resistance component occurs.

More specifically, the low-resistance component residual ratio in unused toner after passage through an air classification apparatus can be obtained by measuring the low-resistance component in toner before the toner passes through the air classification apparatus and the low-resistance component in toner after the toner has passed through the air classification apparatus. For example, a portion of toner mixed with the particulate low-resistance component is passed through a cyclone in which the air amount of an air classification apparatus is 400 to 600 mmHg. The particulate low-resistance component weakly sticking to toner particles separates from the toner particle surfaces, and is removed from the upper portion of the cyclone. The low-resistance component strongly sticking to the toner particle surfaces is collected together with the toner particles from the lower portion of the cyclone. The ratio of the amount of low-resistance-component in the collected toner to the amount of low-resistance component in toner before the toner passes through the air classification apparatus can be calculated by determining these amounts.

As the low-resistance component determination method, it is possible to apply any known analytical determination method in accordance with the type of low-resistance component. Examples are emission spectroscopic analysis, atomic-absorption spectroscopy, and absorptiometric analysis in which toner is decomposed by a wet method and an element of interest is determined, or an element of interest is determined by a dry method by using X-rays or fluorescence.

If the low-resistance component adhesion strength in unused toner is less than 0.95, the amount of low-resistance component in the recycled toner increases. This causes disadvantages such as fogging and toner scattering.

The ratio of the low-resistance component in the recycled toner to the low-resistance component in the toner developed on the image carrier before transfer can be measured by, e.g., extracting a portion of the recycled toner supplied to the developing device through the recycle mechanism and a portion of the untransferred toner developed on the image carrier, and using the above-mentioned determination method.

To set the ratio of the low-resistance component in the toner mixture to the low-resistance component in the recycled toner to 1 to 1.2, and to set the low-resistance component residual ratio in unused toner after passage through an air classification apparatus to 0.95 to 1, the low-resistance component adhesion strength of the toner particles is increased.

The particulate low-resistance component can be strongly adhered to the surfaces of the toner particles by optimizing the mixing conditions of the toner particles and low-resistance component. For example, when the toner particles and low-resistance component are mixed, a surface treatment is preferably performed by a mechanochemical method such as a mechanofusion system or surfusing system. As a consequence, the amount of low-resistance component liberated in the recycled toner can be reduced.

Examples of the mechanochemical processing are mechanical impact force processing and dry mechanochemical processing. In the mechanical impact force processing, child particles can be fixed to the surfaces of mother particles to form particles in a high-speed stream by using the shear force of a rotor and stator and the collision between the particles and between the particles and the walls of the machine. In the dry mechanochemical method, child particles can be fixed to the surfaces of mother particles to form particles by using heat generated by the friction, compression, and shear force between material particles and between the particles and the wall members of the apparatus.

The mechanofusion system is a mechanochemical process. In the mechanofusion process, mother particles and a power material containing child particles are mixed by a dry method to prepare an ordered mixture in which the child particles are sticking to the mother particles. This ordered mixture is placed in a rotary vessel, and pushed against and fixed to the inner wall of the vessel by centrifugal force. In addition, an inner piece having a radius of curvature different from that of the inner wall is applied to the fixed powder material, and strong compression and shear force are also given. This makes it possible to form composite particles, control the particle shape, and perform precise mixing.

The surfusing system is a thermal process. In the surfusing system, a powder material is dispersed in a hot air stream by a special method using compressed air. By heating this powder material to a melting start temperature or higher, it is possible to make the powder spherical, fix child particles to mother particles, or, if the child particles are fine resin particles, form films of the child particles on the mother particles.

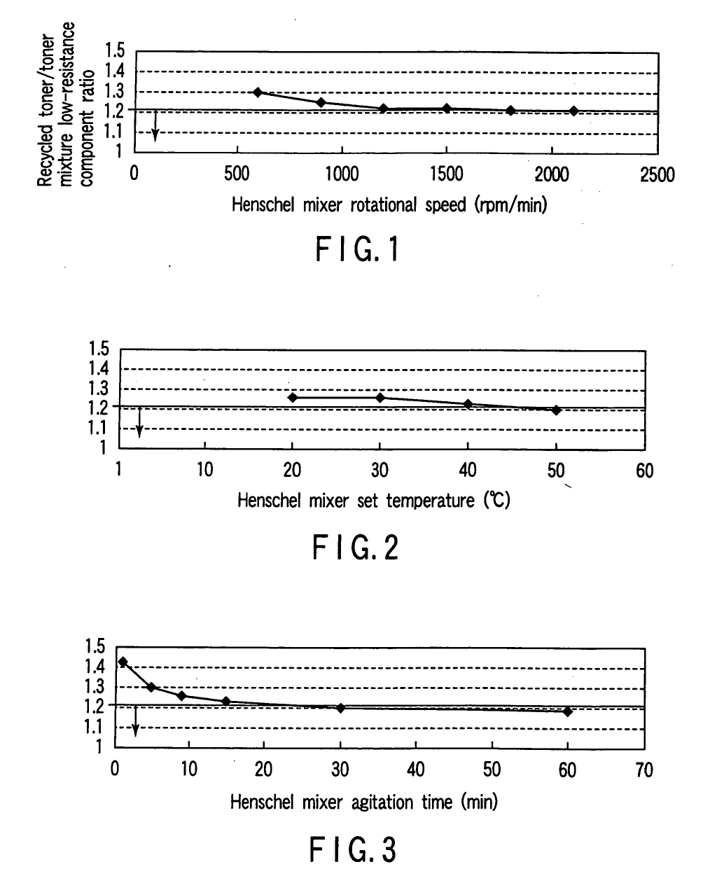

FIG. 1 is a graph showing the relationship between the rotational speed of a Henschel mixer used when the toner particles and low-resistance component were mixed, and the ratio of the low-resistance component in the toner mixture to the low-resistance component in the recycled toner.

Note that the set temperature and agitation time of the Henschel mixer were 30° C. and 9 min, respectively, a 20-L type mixer was used as the Henschel mixer, and 0.5 wt % of titanium oxide NKT90 manufactured by Aerosil were added as the low-resistance component to the toner particles.

As shown in FIG. 1, the ratio was 1.2 or less when the rotational speed of the Henschel mixer was, e.g., 1,200 rpm.

FIG. 2 is a graph showing the relationship between the set temperature of the Henschel mixer used when the toner particles and low-resistance component were mixed, and the ratio of the low-resistance component in the recycled toner to the low-resistance component in the toner developed on the image carrier before transfer. Note that the rotational speed and agitation time of the Henschel mixer were 900 rpm and 9 min, respectively.

As shown in FIG. 2, the ratio was 1.2 or less when the set temperature of the Henschel mixer was, e.g., 50° C. or higher.

FIG. 3 is a graph showing the relationship between the agitation time of the Henschel mixer used when the toner particles and low-resistance component were mixed, and the ratio of the low-resistance component in the recycled toner to the low-resistance component in the toner developed on the image carrier before transfer. Note that the set temperature and rotational speed of the Henschel mixer were 30° C. and 900 rpm, respectively.

As shown in FIG. 3, the ratio was 1.2 or less when the agitation time of the Henschel mixer was, e.g., 30 min or more.

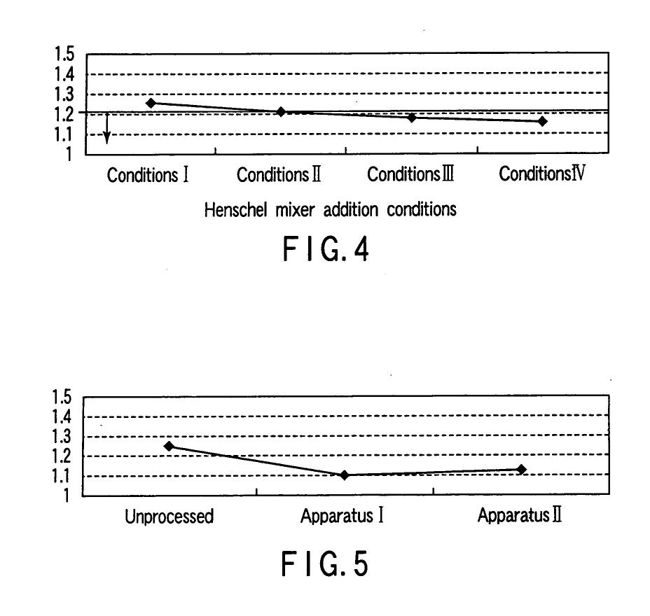

FIG. 4 is a graph showing the ratio of the low-resistance component in the recycled toner to the low-resistance component in the toner developed on the image carrier before transfer, when the rotational speed, set temperature, and agitation time were changed.

Referring to FIG. 4, conditions I were 900 rpm, 30° C., and 9 min, conditions II were 2,100 rpm, 30° C., and 9 min, conditions III were 2,100 rpm, 40° C., and 15 min, and conditions IV were 2,100 rpm, 50° C., and 60 min. Under these conditions, the ratio of the low-resistance component in the recycled toner to the low-resistance component in the toner developed on the image carrier before transfer was measured.

As shown in FIGS. 1 to 4, the ratio of the low-resistance component in the recycled toner to the low-resistance component in the toner developed on the image carrier before transfer can depend upon the mixing conditions of the toner particles and low-resistance component, e.g., the rotational speed, set temperature, and agitation time, and can be adjusted to a desired value by appropriately setting these conditions.

FIG. 5 is a graph showing the processing results of toner which was mixed by the Henschel mixer, and in which the ratio of the low-resistance component in the recycled toner to the low-resistance component in-the toner developed on the image carrier before transfer was 1.25. More specifically, apparatus I indicates the ratio when this toner was further processed by the mechanofusion system at a rotational speed of 2,600 rpm and a set temperature of 25° C. for an agitation time of 3 min. Apparatus II indicates the ratio when the toner was further processed by the surfusing system at a set temperature of 200° C. and a processing air amount of 0.7 m³/min.

As shown in FIG. 5, the low-resistance component can be strongly adhered by further performing mechanochemical processing or thermal processing after mixing.

If the addition amount of the low-resistance component to the toner particles is less than 0.2 wt %, the toner flowability lowers. Therefore, the toner readily remains in a bottle or cartridge to increase the remaining toner amount. If this addition amount exceeds 1.0 wt %, the resistance of the toner lowers. This increases the consumption amount and causes fogging.

Silica particles or hydrophobic silica particles can be further added to the toner particles. The weight ratio of the low-resistance component to the silica particles is preferably 0.2 to 5.0. If the silica particle addition amount is less than 0.2, low charging occurs. This often increases the consumption amount and causes fogging and toner scattering. If the silica particle addition amount exceeds 5.0, high charging occurs. This often decreases the image density and causes halftone graininess.

The toner used in the present invention can be mixed with carrier and used as a two-component developing agent.

The average particle diameter of the carrier is preferably 100 μm or less.

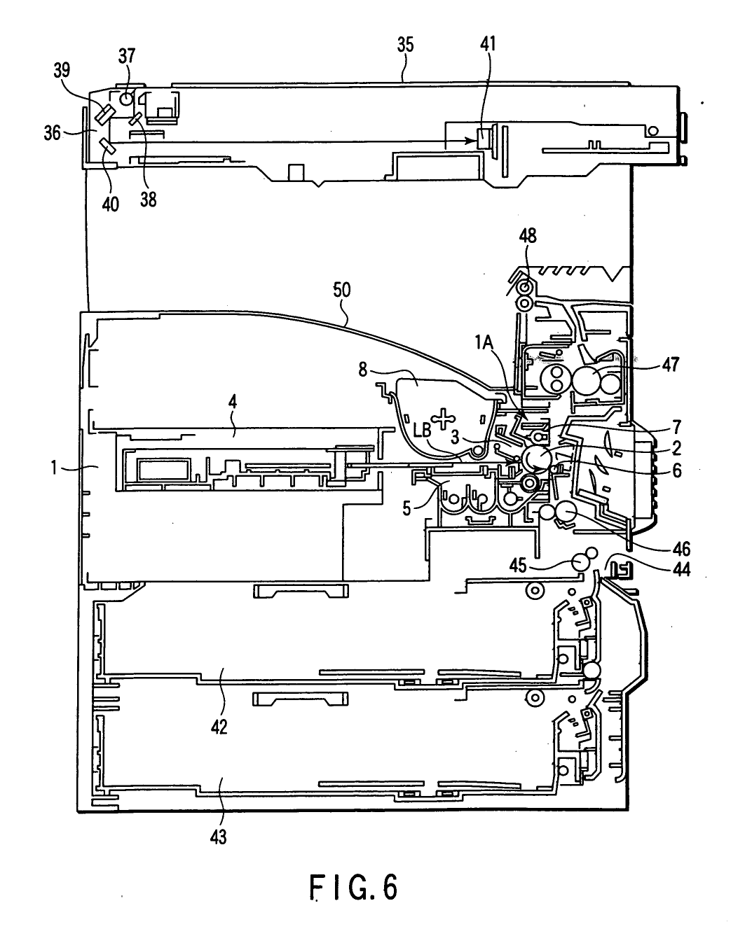

FIG. 6 is a view schematically showing the internal arrangement of an example of an image forming apparatus to which the developing agent of the present invention is suitably applicable.

In FIG. 6, an image forming unit 1A is positioned on one side of a central portion of a copying machine main body 1. The image forming unit 1A has a photo-receptor drum 2 as an image carrier which can rotate in the direction of an arrow. Around the photoreceptor drum 2, a charger 3, laser unit 4, developing device 5, transfer roller 6, and cleaning device 7 are arranged in the order named along the rotational direction of the photoreceptor drum 2. The charger 3 charges the surface of the photoreceptor drum 2. The laser unit 4 is an image forming mechanism for forming an electro-static latent image on the surface of the photoreceptor drum 2. The developing device 5 is a developing mechanism for developing the electrostatic latent image on the photoreceptor drum 2 by toner. The transfer roller 6 is a transfer mechanism for transferring the toner image on the photoreceptor drum 2 onto a sheet of paper. The cleaning device 7 is a removing mechanism for removing residual toner on the photoreceptor drum 2.

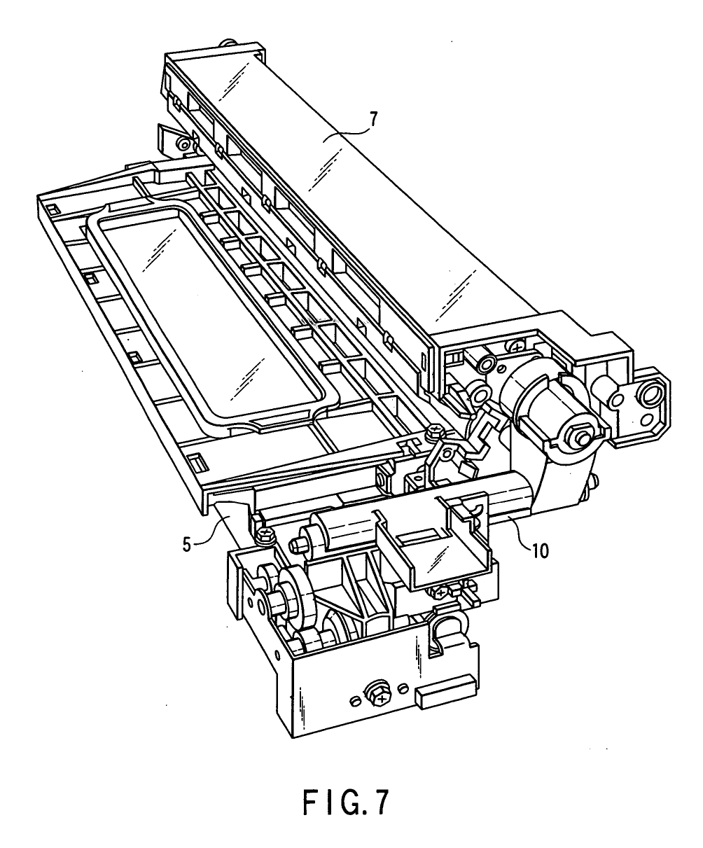

A toner replenishing device 8 as replenishing means is positioned above the developing device 5. The developing device 5 contains a two-component developing agent made of carrier and toner. As shown in FIG. 7, the developing device 5 is connected to the cleaning device 7 via a toner collecting mechanism 10.

An original glass plate 35 is placed on the upper surface of the copying machine main body 1. A scanner 36 for exposing an original on the original glass plate 35 is placed below it. The scanner 36 includes a light source 37, first, second, and third reflecting mirrors 38, 39, and 40, and light-receiving element 41. The light source 37 irradiates an original with light. The first reflecting mirror 38 reflects the reflected light from the original in a predetermined direction. The second and third reflecting mirrors 39 and 40 reflect the reflected light from the first reflecting mirror 38. The light-receiving element 41 receives the reflected light from the third mirror 40.

A plurality of paper feed cassettes 42 and 43 are arranged in the lower portion of the copying machine main body 1. Sheets of paper are supplied from the paper feed cassettes 42 and 43. Each sheet is conveyed upward via a conveyor system 44. The conveyor system 44 includes a pair of conveyor rollers 45, a pair of registration rollers 46, an image transfer portion, a pair of fixing rollers 47, and a pair of discharge rollers 48.

To form an image, the light source 37 irradiates an original on the original glass plate 35 with light. This light is reflected by the original and received by the light-receiving element 41 via the first to third reflecting mirrors 38 to 40, thereby reading the original image. On the basis of this read information, the laser unit 4 irradiates the surface of the photoreceptor drum 2 with a laser beam LB. The surface of the photoreceptor drum 2 is negatively charged by the charger 3, and exposed to the laser beam LB emitted from the laser unit 4. Consequently, the surface potential of the photoreceptor drum 2 in a region corresponding to the image portion of the original approaches 0 in accordance with the image density, thereby forming an electrostatic latent image. This electrostatic latent image opposes the developing device 5 by the rotation of the photoreceptor drum 2. In this position, the electrostatic latent image turns into a visual image by adsorbing toner supplied via carrier.

A sheet is supplied from the paper feed cassette 42 or 43, conveyed, and registered by the registration rollers 46. This sheet is fed into the image transfer portion between the transfer roller 6 and photoreceptor drum 2. The visual image on the photoreceptor drum 2 is transferred onto the positively charged sheet.

The sheet on which the image is transferred is conveyed to the pair of fixing rollers 47 by which the image is fixed on the sheet by pressure and heat. After this fixing, the sheet is discharged onto a paper discharge tray 50 via the pair of paper discharge rollers 48.

Toner not transferred onto the sheet in the image transfer portion described above and remaining on the surface of the photoreceptor drum 2 is removed by the cleaning device 7, returned to the developing device 5 by the collecting mechanism 10, and reused as recycled toner. Also, when toner in the developing device 5 is consumed by development, the toner replenishing vessel 8 replenishes unused toner. In this manner, the recycled toner and unused toner are mixed in the developing device 5, and the obtained toner mixture is used in development.

### EXAMPLES

### Examples 1-8 & Comparative Examples 1-11

The following toner particle materials were prepared.

| | | | |
|---|---|---|---|
| Binder resin | Polyester resin | 100 | parts by weight |
| Coloring agent | Carbon black | 6 | parts by weight |

| | | |
|---|---|---|
| Polypropyrene wax | 4 | parts by weight |
| Charging control agent | 1 | part by weight |

The above toner particle materials were mixed, and the obtained mixture was melted and kneaded. The obtained kneaded product was coarsely pulverized and then finely pulverized. The obtained fine pulverized product was classified to obtain toner particles having an average particle diameter of 8 μm.

Titanium oxide NKT90 (average particle diameter=20 nm) manufactured by Aerosil was added in amounts shown in Table 1 (to be presented later) to the obtained toner particles, and hydrophobic silica R974 (average particle diameter=12 nm) manufactured by Aerosil was added at weight ratios shown in Table 1 to the titanium oxide, under mixing conditions shown in Table 1 by using a Henschel mixer, thereby obtaining toner components.

These toner components were mixed with carrier (average particle diameter=45 μm) manufactured by POWDERTECH to obtain developing agents.

The residual ratio of the low-resistance component after passage through an air classification apparatus, the ratio of the low-resistance component in recycled toner to the low-resistance component in toner developed on the image carrier before transfer, and the remaining toner amount in the cartridge were checked for each obtained toner.

Ratio of low-resistance component after passage through air classification apparatus

Toner was passed through a cyclone of an air classification apparatus, fine particles such as a separated low-resistance component were removed from the upper portion of the cyclone, and the toner particles having the low-resistance component adhered are collected from the lower portion of the cyclone. The amount of low-resistance component in the toner unprocessed by the air classification apparatus and that in the collected toner were determined, and the ratio was calculated.

Ratio of low-resistance component in recycled toner to low-resistance component in toner developed on image carrier before transfer

Toner was supplied to an image forming apparatus having the same arrangement as shown in FIG. 6, and a portion of recycled toner supplied to the developing device through the recycle mechanism and a portion of toner after development and before transfer were extracted. Note that the amount of toner to be developed was 2 to 4 g per 29 cm×41 cm, and the transfer efficiency was 80 to 95. The amount of low-resistance component of each toner was determined by using an X-ray elementary analyzer, and the ratio was calculated.

Fogging

Fogging on the photoreceptor was adhered on a testing tape, and evaluated by measuring the reflectance. ◯ indicates a reflectance of 6.0% or less, and X indicates a reflectance exceeding 6.0%.

Remaining Toner Amount in Cartridge

Toner was dropped from the cartridge by using a dedicated jig, and the amount of toner that was not dropped was measured. ◯ indicates an amount of 33 g or less per 500 g, and X indicates an amount exceeding 33 g per 500 g. This remaining toner amount indicates the flowability of the toner.

The obtained results are shown in Table 2 (to be presented later).

When images were formed by using the obtained developing agents, good images having nether fogging nor an excess remaining toner amount were obtained even after 100,000 copies were formed.

### Examples 9 & 10

Toner components were obtained following the same procedures as in Example 1 except that processing was performed by the mechanochemical or surfusing system after a normal external addition process was performed by using a Henschel mixer.

In the same manner as in Example 1, the residual ratio of the low-resistance component after passage through an air classification apparatus, the ratio of the low-resistance component in recycled toner to the low-resistance component in toner developed on the image carrier before transfer, and the remaining toner amount in the cartridge were checked for each obtained toner.

The obtained results are shown in Table 2.

TABLE 1

| | Low-resistance | Low-resistance | Mixing conditions | Another |
|---|---|---|---|---|
| | component addition | component/ | rotational speed/ | processing |
| | amount (%) | silica ratio | time/temperature | apparatus |
| Example 1 | 0.5 | 1 | 2100 rpm/60 min/50° C. | — |
| Example 2 | 0.2 | 0.2 | 2100 rpm/60 min/50° C. | — |
| Example 3 | 1.0 | 0.2 | 2100 rpm/60 min/50° C. | — |
| Example 4 | 0.2 | 5.0 | 2100 rpm/60 min/50° C. | — |
| Example 5 | 1.0 | 5.0 | 2100 rpm/60 min/50° C. | — |
| Example 6 | 0.5 | 1 | 2100 rpm/15 min/40° C. | — |
| Example 7 | 0.5 | 1 | 900 rpm/30 min/30° C. | — |
| Example 8 | 0.5 | 1 | 900 rpm/9 min/50° C. | — |
| Example 9 | 0.5 | 1 | — | Mechanochemical |
| Example 10 | 0.5 | 1 | — | Surfusing |
| Comparative | 0.2 | 0.2 | 900 rpm/9 min/20° C. | — |
| Example 1 | | | | |
| Comparative | 1.0 | 0.2 | 900 rpm/9 min/20° C. | — |
| Example 2 | | | | |
| Comparative | 0.2 | 5.0 | 900 rpm/9 min/20° C. | — |
| Example 3 | | | | |
| Comparative | 1.0 | 5.0 | 900 rpm/9 min/20° C. | — |
| Example 4 | | | | |
| Comparative | 0.19 | 0.2 | 2100 rpm/60 min/50° C. | — |
| Example 5 | | | | |
| Comparative | 1.1 | 0.2 | 2100 rpm/60 min/50° C. | — |
| Example 6 | | | | |
| Comparative | 0.19 | 5.0 | 2100 rpm/60 min/50° C. | — |
| Example 7 | | | | |
| Comparative | 1.1 | 5.0 | 2100 rpm/60 min/50° C. | — |
| Example 8 | | | | |
| Comparative | 0.5 | 1 | 2100 rpm/9 min/20° C. | — |
| Example 9 | | | | |
| Comparative | 0.5 | 1 | 900 rpm/30 min/20° C. | — |
| Example 10 | | | | |
| Comparative | 0.5 | 1 | 900 rpm/9 min/30° C. | — |
| Example 11 | | | | |

TABLE 2

| | Low-resistance | Recycled toner/developed | | |
|---|---|---|---|---|
| | component | toner low-resistance | | Remaining |
| | residual ratio | component ratio | Fogging | toner amount |
| Example 1 | 0.97 | 1.16 | ◯ | ◯ |
| Example 2 | 0.98 | 1.14 | ◯ | ◯ |
| Example 3 | 0.97 | 1.16 | ◯ | ◯ |
| Example 4 | 0.98 | 1.14 | ◯ | ◯ |
| Example 5 | 0.97 | 1.15 | ◯ | ◯ |
| Example 6 | 0.96 | 1.18 | ◯ | ◯ |
| Example 7 | 0.95 | 1.2 | ◯ | ◯ |
| Example 8 | 0.95 | 1.2 | ◯ | ◯ |
| Example 9 | 0.98 | 1.1 | ◯ | ◯ |
| Example 10 | 0.98 | 1.12 | ◯ | ◯ |
| Comparative | 0.85 | 1.35 | X | ◯ |
| Example 1 | | | | |
| Comparative | 0.74 | 1.40 | X | ◯ |
| Example 2 | | | | |
| Comparative | 0.86 | 1.35 | X | ◯ |
| Example 3 | | | | |
| Comparative | 0.77 | 1.37 | X | ◯ |
| Example 4 | | | | |
| Comparative | 0.98 | 1.16 | ◯ | X |
| Example 5 | | | | |
| Comparative | 0.93 | 1.21 | X | ◯ |
| Example 6 | | | | |
| Comparative | 0.90 | 1.25 | X | X |
| Example 7 | | | | |
| Comparative | 0.88 | 1.26 | X | ◯ |
| Example 8 | | | | |
| Comparative | 0.85 | 1.34 | X | ◯ |
| Example 9 | | | | |
| Comparative | 0.85 | 1.34 | X | ◯ |
| Example 10 | | | | |
| Comparative | 0.88 | 1.26 | X | ◯ |
| Example 11 | | | | |

By appropriately changing the conditions of mixing of titanium oxide particles and silica particles into toner particles as shown in Table 1, it is possible, as shown in Table 2, to control the weight ratio of the low-resistance component in the recycled toner to the low-resistance component in the toner developed on the image carrier before transfer to 1.2 or less, and control the low-resistance component residual ratio in unused toner after passage through an air classification apparatus to 0.95 or more.

In each of Examples 1 to 10 and Comparative. Example 5, the low-resistance component residual ratio of unused toner after passage through an air classification apparatus was 0.95 or more, and no fogging occurred. However, fogging occurred in Comparative Examples 1 to 4 and 6 to 11 in each of which this low-resistance component residual ratio was less than 0.95. Also, in each of Comparative Examples 5 and 7 in which the addition amount of low-resistance component was less than 0.2 wt %, the remaining toner amount increased, and the toner flowability decreased.

From the foregoing, it is possible to prevent fogging and toner scattering, obtain good images, and increase the toner flowability by the use of a developing agent in which the addition amount of low-resistance component to toner particles is 0.2 to 1.0 wt %, the weight ratio of the low-resistance component in recycled toner to the low-resistance component in toner developed on the image carrier before transfer is 1.0 to 1.2, and the low-resistance component residual ratio in unused toner after passage through an air classification apparatus is 0.95 to 1.0.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

What is claimed is:

1. A developing agent for use in an image forming apparatus which comprises a toner recycle mechanism for collecting and reusing a toner remaining on an image carrier after transfer, and applies to development a toner mixture obtained by mixing recycled toner in unused toner, containing:
toner having toner particles containing a coloring agent and a binder resin, and a particulate low-resistance component and silica particles added to surfaces of the toner particles,
wherein an addition amount of the low-resistance component with respect to the toner particles is 0.2 to 1.0 wt %, a weight ratio of the low-resistance component in the recycled toner to the low-resistance component in toner developed on the image carrier before transfer is 1.0 to 1.2, and a low-resistance component residual ratio of the unused toner after passage through an air classification apparatus is 0.95 to 1.0.

2. A developing agent according to claim 1, wherein silica particles are further added to the toner particle surfaces, and a ratio of a weight of the silica particles to a weight of the low-resistance component is 0.2 to 5.0.

3. A developing agent according to claim 1, wherein the particulate low-resistance component is adhered on the toner particle surfaces by at least one surface treatment selected from the group consisting of a mechanochemical process and thermal process.

4. A developing agent according to claim 3, wherein the surface treatment is at least one of a mechanofusion system and surfusing system.

5. An image forming apparatus comprising:
an image carrier;
a developing device which opposes the image carrier, contains a developing agent having toner particles containing a coloring agent and a binder resin, and a particulate low-resistance component and silica particles added to surfaces of the toner particles, and forms a toner image by developing an electrostatic latent image formed on the image carrier in accordance with image information;
a toner replenishing mechanism which supplies unused toner to the developing device;
a transfer device which transfer the toner image onto a transfer medium;
a cleaning mechanism which removes toner remaining on the image carrier after transfer; and
a toner recycle mechanism which collects the removed toner, and supplies the collected toner as recycled toner to the developing device,
wherein an addition amount of the low-resistance component with respect to the toner particles is 0.2 to 1.0 wt %, a weight ratio of the low-resistance component in the recycled toner to the low-resistance component in toner developed on the image carrier before transfer is 1.0 to 1.2, and a low-resistance component residual ratio of the unused toner after passage through an air classification apparatus is 0.95 to 1.0.

6. An apparatus according to claim 5, wherein silica particles are further added to the toner particle surfaces, and a ratio of a weight of the silica particles to a weight of the low-resistance component is 0.2 to 5.0.

7. An apparatus according to claim 5, wherein the particulate low-resistance component is adhered on the toner particle surfaces by at least one surface treatment selected from the group consisting of a mechanochemical process and thermal process.

8. An apparatus according to claim 7, wherein the surface treatment is at least one of a mechanofusion system and surfusing system.
